(19) United States
(12) Patent Application Publication
(10) Pub. No.: US 2015/0193756 A1
(43) Pub. Date: Jul. 9, 2015

(54) Method and System for Providing a Service Associated With Sale of a Product

(71) Applicant: Touch Networks Pty Ltd, Melbourne (AU)

(72) Inventor: Jason Andrew Van, North Sydney (AU)

(21) Appl. No.: 14/661,898

(22) Filed: Mar. 18, 2015

Related U.S. Application Data
(62) Division of application No. 13/384,083, filed on Apr. 6, 2012.
(60) Provisional application No. 61/228,921, filed on Jul. 27, 2009.
(60) Provisional application No. 61/225,529, filed on Jul. 14, 2009.

(51) Int. Cl. G06Q 20/20; G06Q 30/06; G07G 1/14

(52) U.S. Cl. CPC G06Q 20/202; G07G 1/14; G06Q 20/204; G06Q 30/0611

(57) ABSTRACT

A method and system for providing a service associated with sale of a product from a merchant to a customer at a point of sale terminal connected to a network. The method comprising the steps of offering to provide the service associated with sale of the product to said customer during purchase of said product at the point of sale terminal, providing one of a plurality of identification numbers held in a database connected to the network at the point of sale terminal in association with the offered service and providing said provided identification number to said customer, and subsequently providing customer access over the network to permit said customer to enter purchase related details into the database to be associated with the provided identification number, thereby minimising time required at the point of sale terminal.

### RELATED APPLICATIONS

This application is a divisional of U.S. application Ser. No. 13/384,083, filed Apr. 6, 2012, which is the National Stage of International Application No. PCT/AU2010/000893, filed Jul. 14, 2010, which claims the benefit of U.S. Provisional Application Nos. 61/228,921, filed Jul. 27, 2009, and 61/225,529, filed Jul. 14, 2009, the disclosures of which are incorporated herein by reference in their entireties.

### FIELD

The present invention relates to a method and system for providing a service associated with sale of a product, and particularly, but not exclusively, to sale of a product at a point of sale terminal; and to computer program code for performing this method. The present invention is of particular although not exclusive application in providing the service from a merchant to a customer whereby the customer is permitted to enter purchase related details into a database subsequent to purchasing the product to minimise time required at the point of sale terminal by a sales person.

### BACKGROUND

Hitherto, a merchant wishing to provide a service associated with sale of a product to a customer, such as insurance or an extended warranty for that product, would typically offer to provide the service during purchase of the product at a point of sale terminal. That is, a sales person employed by the merchant would typically offer the customer the service at the same time the product is purchased and thus would use the point of sale terminal to complete the transaction for purchasing the product, purchasing the service, and subsequently activating the service.

It would be appreciated by those skilled in the art that purchasing a product may require few, if any, customer details to be entered into a database at a point of sale terminal. In contrast, providing a service such as an extended warranty may require considerable quantities of customer details to be entered into the database. For example, details such as the type of product, serial number of product and customer identification details are typically entered into a database in case they are required for subsequent identification of the customer and the product by a service provider, such as an insurer. However, the above process results in considerable delays experienced by the customer at the point of sale terminal as the sales person is required to enter these details into the database. Furthermore, the delays may result in customer frustration and reduced volume of transactions at the point of sale terminal for the merchant.

Accordingly, there is a need for an improved method and system.

### SUMMARY OF THE INVENTION

Therefore, according to a first broad aspect of the present invention there is provided a method for providing a service associated with sale of a product from a merchant to a customer at a point of sale terminal connected to a network, the method comprising:

offering to provide the service associated with sale of the product to said customer during purchase of said product at the point of sale terminal,

providing one of a plurality of identification numbers held in a database connected to the network at the point of sale terminal in association with the offered service and providing said provided identification number to said customer, and subsequently

providing customer access over the network to permit said customer to enter purchase related details into the database to be associated with the provided identification number, thereby minimising time required at the point of sale terminal.

In one embodiment, a service associated with sale of a product may be at least one insurance service, such as a warranty, provided by a service provider, such as an insurer, to a merchant to provide to their customers. The service provider may also be permitted access over the network to the database to retrieve or change details stored in the database relating to the provided service.

In one example, the method may be used with respect to a department store environment where the service provider may offer to provide the merchant, e.g. the store, more than one insurance type service for different products sold by the store to customers. For example, the merchant may offer to customers 12 or 24 month extended warranties for all electronic goods when a customer purchases such goods. It will be appreciated by those skilled in the art that the insurer may wish to change some details in the database, such as the current price for any services offered to customers, or the insurer may wish to retrieve customer entered details when an insurance claim is received from a customer. The customer entered details may be stored in the database in association with the provided identification number so that they can be readily identified and retrieved by the insurer.

In another embodiment, the customer may purchase the service when purchasing a product at the point of sale (POS) terminal. However, in an alternative embodiment, the customer may be permitted to purchase the service subsequent purchasing the product by entering purchase related details, including debit or credit details, into the database within a predetermined time. That is, the customer may make arrangements to purchase the service at the time of purchasing the product, at the point of sale terminal, but make the required payment, typically using a credit card, remote from the terminal at a later time within a predetermined time period. In a further embodiment, the customer may purchase the service at any time for a product previously purchased. However, in all the above embodiments, the customer is required to enter purchase related details remote from the point of sale terminal to minimise time required at the point of sale terminal by a sales person. Also, the customer may be provided a unique identification number during purchase at the point of sale terminal to subsequently obtain access over the network to the database to enter details. The identification number may be provided in the form of a printed slip, oral instruction from the sales person, displayed on the point of sale terminal, or displayed via an encodable card with the identification number displayed and encoded thereon.

In another embodiment, a quote for the service associated with sale of a product may be offered to a customer, with an accompanying associated quote number, at the point of sale terminal at the time of purchase of a product. For example, the customer may be provided a quote with a unique quote number for provision of a service and will have a predetermined time, such as one hour, to accept the quote and thus accept the service at the point of sale terminal. If the quote is not accepted within this time period by the customer, a further quote with a new quote number may be required before the service can be accepted. Furthermore, upon acceptance of the service by the customer, the quote number may be associated with the provided identification number in the database, by the point of sale terminal, so that the customer may subsequently use both the provided identification number and the quote number for authentication to obtain customer access over the network to enter purchase related details into the database to provide details for a service provider and/or to confirm and/or register the service.

In one embodiment, the customer may be provided with an encodable card with the provided identification number encoded and displayed thereon. For example, the card may be a plastic card like a typical credit card with the identification number displayed in embossed numerals on one surface of the card. Furthermore, the card may have a magnetic stripe, typically on the other surface, for use with a card reader component of a point of sale terminal, whereby the magnetic stripe is encoded to contain the identification number. Alternatively, the card may have an embedded circuit or tag with the identification number encoded thereon, such as a RFID tag. It is to be appreciated that each card may have an individual identification number displayed and encoded thereon corresponding to an individual identification number held in the database. A skilled person would also envisage that the card may be a blank card that could be encoded with a unique identification number at the point of sale terminal when the product is purchased. In an example, the identification number encoded onto the card and the quote number are associated together in the database so that they can be used for subsequent authentication by the customer. This may be achieved by having the provided card's magnetic stripe swiped though the card reader of the point of sale terminal, which reads the identification number from the magnetic stripe for association with the quote number in the database when the customer accepts the quoted service.

In one example, the customer obtains access over the network to the database from a terminal remote from the network, e.g. a home PC connected to the Internet. In another example, the customer obtains access from a dedicated terminal, e.g. a terminal located within the department store. In both examples, purchase related details are entered by the customer to minimise the time required by a sales person at the point of sale terminal. It is also to be appreciated by those skilled in the art that the customer access may be provided via a communication medium, such as a wide area network (WAN) (e.g. Internet). In this embodiment, components employed by the method, such as the customer terminal and the database, may be connected via the WAN but located in different cities.

In an example, if the method is to be implemented within a department store environment, e.g. an environment with multiple POS terminals and a central database within the store, a local area network (LAN) may be used to ensure reliability of data transfer from the POS terminals to the database across the network. In other example, the POS terminal may be an EFTPOS (Electronic Funds Transfer at Point of Sale) terminal or device which communicates across an EFTPOS network. It is to be appreciated by those skilled in that art that an EFTPOS network may be a dedicated GPRS (General Packet Radio Service) or IP (Internet Protocol) network. In the example, the above method may be implemented by a sole trader type store using only a single bank issued EFTPOS device. In this case, the EFTPOS device may communicate over the EFTPOS network to a bank to complete acceptance and purchase of the service associated with sale of a product. It is envisaged that the bank may also communicate purchase information to the database across the network.

According to another broad aspect of the present invention there is provided a system for providing a service associated with sale of a product from a merchant to a customer at a point of sale terminal connected to a network, the system comprising:

said point of sale terminal adapted to receive payment for purchase of said product, and to provide one of a plurality of identification numbers held in a database connected to the network in association with a service associated with sale of the product offered to said customer, and

a network access means adapted to permit said customer access over the network to enter purchase related details into the database to be associated with the provided identification number, thereby minimising time required at the point of sale terminal.

According to another aspect of the present invention there is provided a computer program code which when executed implements the above method.

According to another aspect of the present invention there is provided a computer readable medium comprising the above program code.

According to another aspect of the present invention there is provided a data signal comprising the above program code.

According to another aspect the present invention extends to transmitting or receiving the above program code.

### BRIEF DESCRIPTION OF DRAWINGS

In order that the invention can be more clearly ascertained, examples of embodiments will now be described with reference to the accompanying drawings wherein:

FIG. 1 is a schematic view of a system for providing a service associated with sale of a product from a merchant to a customer at a point of sale terminal connected to a network according to an embodiment of the invention;

FIG. 2 is a flow chart of a method implemented by the system of FIG. 1;

FIG. 3a is a schematic view of the system of FIG. 1;

FIG. 3b is a schematic view of the system of FIG. 1 showing an EFTPOS network;

FIG. 4 is a schematic view of the system of FIG. 1 showing an encodable card and the point of sale terminal having a card reader connected thereto;

FIG. 5 is a flow chart of the method of FIG. 2 showing additional step of providing a quote; and

FIG. 6 is a flow chart of the method of FIG. 2 showing the additional steps of providing at least one insurance service associated with sale of the product from a service provider, providing a quote for the service based on the insurance premiums, and providing service provider access.

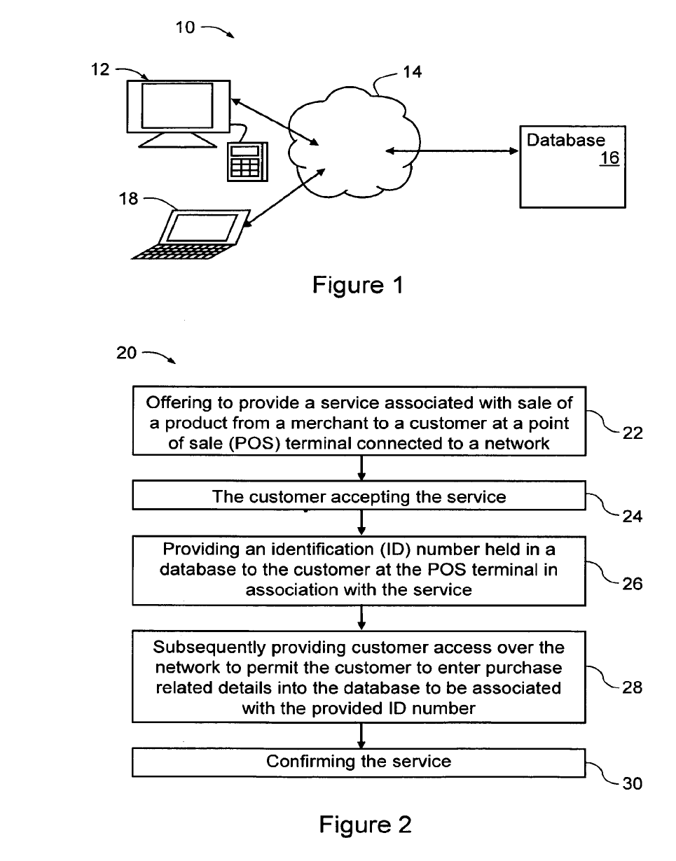

### DETAILED DESCRIPTION

According to the embodiment, there is provided a system 10 for providing a service associated with sale of a product from a merchant to a customer at a point of sale (POS) terminal 12 connected to a network 14. As described above, the service may be an insurance type service, provided by a service provider such as an insurer, offered to a customer purchasing a product. For example, the customer may be offered by the merchant a 12 month extended warranty when purchasing a plasma television at the point of sale (POS) terminal 12. If the customer accepts the extended warranty, the merchant, or a sales person employed by the merchant, receives payment for purchase of the television and the warranty at the POS terminal 12 and provides one of a plurality of unique identification numbers associated with the warranty service, held in a database 16, to the customer. The provided identification number can then be used to permit customer access via a customer access terminal 18 over the network 14 to the database 16 to enter purchase related details, including customer identification details, e.g. driver's license number, and details of the purchased television, e.g. serial number. Thus, the responsibility for entering purchase related details is shifted to the customer, rather than the merchant, to minimise the time required at the point of sale terminal.

FIG. 2 is a flow chart of a method 20 implemented by the system described above for providing a service associated with sale of product. The method 20 includes first offering 22 to provide the service associated with the sale of a product. In reference to the above example, the extended warranty for the plasma television is first offered to the customer at the time of purchase of the television. The customer may accept 24 the warranty service and the method 20 then provides 26 an identification number held in a database to the customer at the time of purchase of the television. Subsequent the purchase of the television and acceptance of the extended warranty, the method 20 includes providing 28 to customer access over the network to permit the customer enter purchase related details into the database to be associated with the provided identification number so that the product and the customer can be readily identified and retrieved. In the above example, the customer confirms 30 the warranty service by entering purchase related details remote from the POS terminal, e.g. at a terminal at home or a terminal with the department store but not by the sales person.

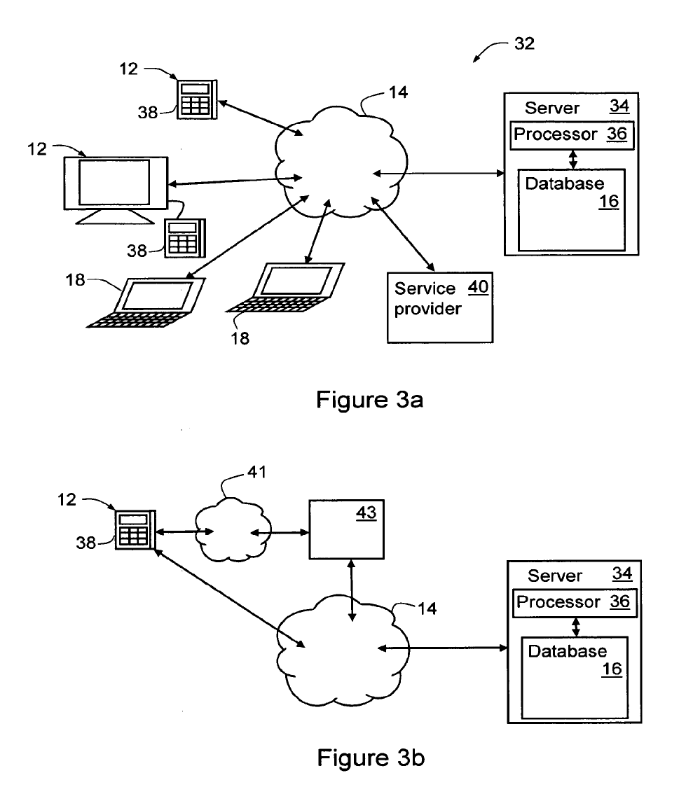

A system 32 for providing a service, such as the warranty service, is shown in FIG. 3a. In the embodiment shown, there are multiple POS terminals 12, connected to the network 14, which are used by the merchant to allow customers to purchase both products and services. In the above example where the merchant is a department store, the store may include multiple POS terminals and multiple sales people. In an alternative example, the network 14 may connect a number of stores with multiple POS terminals. Furthermore, it can be seen that the multiple POS terminals 12 employed by the merchant to facilitate payment of products and/or services may include integrated type POS terminals, including a computer, display and an EFTPOS device 38, or stand alone EFTPOS devices 38 connected to the network 14.

In addition, it can be seen that the database 16 is in a server 34, in a client—server configuration, where the server requires a processor 36 to process instructions received from POS terminals, client terminals 18 or service provider terminals 40, to access the database 16 to enter, retrieve or change information held within. It is to be appreciated by those skilled in the art that the server 34 also contains other hardware to enable the database 16 to function which are not shown, such as a power supply, hard drive, etc, and requisite software, such as an operating system, as is known in the retailing industry.

The service provider terminal 40 also connects to the network 14 and is adapted to permit the service provider, e.g. the insurer, to retrieve information from the database once a secure login is received by the server 34. For example, in the case where the service provider is an insurer for more than one merchant, the service provider accesses the database 16 to view details regarding the services accepted and purchased by customers. The purchase related details entered into the database 16 can be retrieved by the service provider terminal 40, such as when an insurance claim is received. In addition, the service provider, via the terminal 40, may wish to upload prices at which the merchant is to provide services to customers in real-time. In this case, these prices are also stored in the server 34 (and may be in the database 16) to enable the merchant, via the connected POS terminal 12, to provide a quote for the offered service to a customer, at the time of purchase of a product, based on these uploaded prices. For example, the service provider may obtain access to the server 34 to enter acceptable prices, or ranges of prices, for insurance services offered for products provided by merchants to customers. The entered prices are then retrieved from the server 34 by a quoting means incorporated into the point of sale terminal 12 so that a quote can be provided to customers. Furthermore, a quote number is generated by the POS terminal 12 for identification of the quote at the time of purchase.

An alternative embodiment of a system for providing a service, such as the warranty service, is shown in FIG. 3b. In this embodiment, the POS terminal 12 is an EFTPOS device 38 which communicates, via a dedicated EFTPOS network 41, to a bank 43 for customers to purchase products and services. In this case, the merchant may be a sole trader with a single EFTPOS device 38 which may also be connected to the network 14 to associate a generated quote number with a provided identification number in the database 16 when the customer accepts the service. The customer is still required to subsequently enter purchase related details from a terminal 18 remote from the EFTPOS device 38 to minimise time required of the merchant.

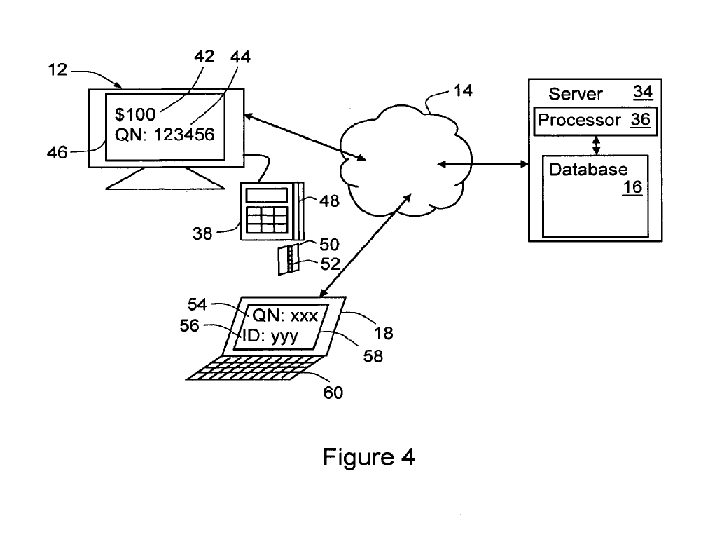

In a further example, the service provider may wish to offer to a merchant a 12 month extended warranty for a plasma television for $100 for provision to a customer. Thus, when a customer purchases the television from the merchant, the customer is quoted $100 for the 12 month warranty and is provided a quote number generated by the POS terminal 12, which is then associated with the quote in the database 16 by the POS terminal 12. FIG. 4 shows an integrated type POS terminal 12 adapted to display the quote 42 for $100 to the customer and the associated quote number 44 QN: 123456 on a display 46. Alternatively, the quote and quote number could be provided to the customer via a printed receipt or provided verbally.

The quoted price of $100 may expire within a predetermined time, such as 60 minutes from first receiving the quote at the POS terminal 12. In the example shown in FIG. 4, the POS terminal 12 has an EFTPOS device 38 with a magnetic stripe reader 48 for reading a magnetic stripe of a card 50. The card 50 is an encodable type card, such as a credit card with a magnetic stripe, has a unique identification number, corresponding to one of the plurality of identification numbers held in the database 16, encoded thereon and displayed on one surface 52. Therefore, a plurality of identification cards 50 may be located at the POS terminal 12 for use by the merchant and a card with one identification number provided to the customer upon acceptance of the service. It is to be appreciated by those skilled in the art that if a second service is purchased by the customer, a second card is to be provided. However, it is envisaged that a single card may be encoded to have more than one identification number and in this case the card reader 48 may also write to the card. In any event, the card reader 48 is adapted to read a magnetic stripe of a card, such as a credit card when making a purchase of a product or a service, or a magnetic stripe of the identification card 50 to identify which identification number from the plurality held on the database 16 is to be associated with the quoted service of $100 for the 12 months extended warranty for the plasma television.

Furthermore, the point of sale terminal 12 reads the identification number from the card 50 and accesses the network 14 to associate the identification number with the quote number 44 in the database 16 of the server 34 to ensure accurate records and to provide additional security for the customer. That is, prior to entering purchase related details into the database 16, the customer is required to enter both the associated quote number 44 and identification number displayed on the surface 52 of the card 50 for authentication over the network 14. The customer using a remote access means, such as home terminal 18, enters the quote number 54 and the identification number 56, as shown on display 58, via a keyboard 60 of the terminal 18. Once access is obtained, the customer can then enter purchase related details such as the product details, e.g. brand, make, model, colour, size of the television, serial number and photos (if necessary). In addition, the customer can then enter further identification details such as email, postal addresses and date of birth to receive correspondence relating to the warranty service.

In the above example, the quote number displayed 44 to the customer at the POS terminal 12 may also be a unique identifier to further enhance security of access over the network 14. A person skilled in the art will appreciate that the quote number is a number generated from an algorithm and, in one example, the quote number is a 12 digit number generated from a list of numbers with a date stamp, e.g. 123420090512—being 12 May 2009. Furthermore, the person skilled in the art will appreciate that the plurality of identification numbers held in the database are generated before being provided, encoded and displayed on cards 50 for the customers. For example, the identification numbers may be bank identification numbers (BINs), or Issuer Identification Numbers (IINs), which are generated in accordance with relevant international standards (e.g. ISO/IEC 7812). BIN/IIN's are generally used with respect to credit cards and are 16 digits in length. Thus, with respect to the above example, each provided card 50 corresponds to one of a plurality of identification numbers held in the database 16 and those numbers are 16 digit BIN/IINs displayed and encoded thereon which can be read by a customer using his/her eyes and a card reader 48. In an example, one card 50, with a unique identification number, is provided upon acceptance of the warranty service by a customer and is swiped through the card reader 48 so that the BIN/IIN encoded on the card can be read and the POS terminal 12 can associate it with the provided quote number 44 in the database 16 of the server 34.

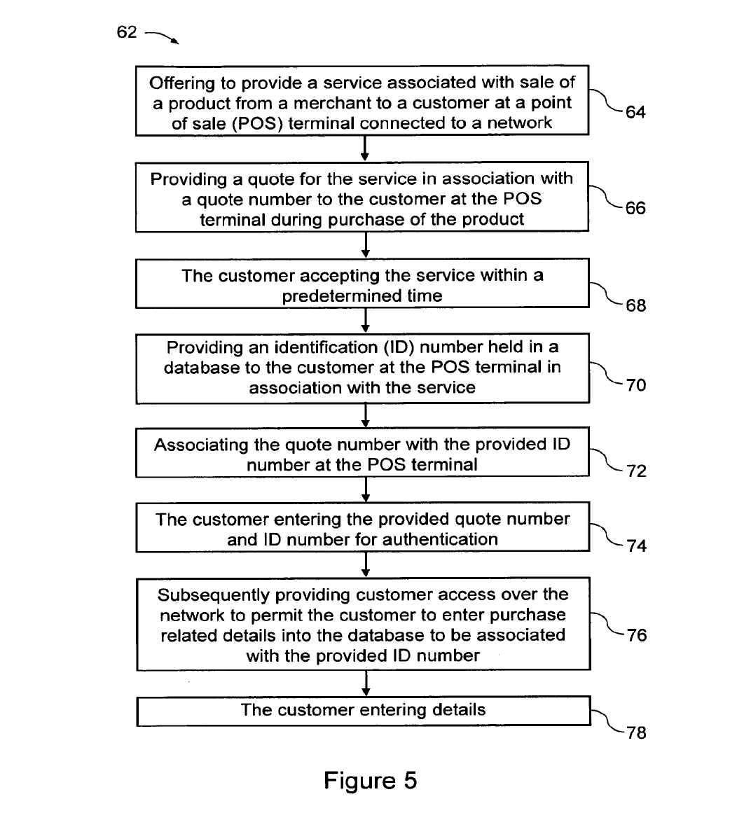

The method 62 of providing a service such as an extended warranty for a television, as given in the above example, is shown in more detail in FIG. 5. The method 62 includes the merchant first offering 64 to provide the service to the customer at the POS terminal. It is envisaged that the customer will ask for a quote during purchase of a product and the merchant then provides 66 the quote based on information stored in a database relating to the product, such as the type and/or category of product (e.g. plasma televisions—electronic goods), the length of the warranty desired, etc. Using this information by the POS terminal connected via a network to the database, including price information inputted by a service provider, a sales person employed by the merchant can provide the quote and an associated quote number on a printed voucher to the customer at the POS terminal.

If the quote is acceptable, the customer accepts 68 the quoted service within a given time period (60 minutes) of it being issued and then purchases the service at the POS terminal. It is to be appreciated that other time limits may be employed, such as 120 minutes in a large department store environment. In this case, the customer may require further time to purchase a product at one POS terminal and enquire about the warranty service whilst continuing to browse other products within the store. In the case where the customer declines to accept the quote within the given time period, the quote expires but a record of the quote, date, type and/or category of product will be recorded by the POS terminal, which connects via the network to existing inventory databases stored in a server, for data collection by the service provider. In the above case, if the customer wishes to accept the service after expiry of the 60 minute period, the POS terminal will prompt the sales person to issue a new quote which may be at a different price to the first quote thus enticing the customer to accept the first quote within the given time period.

If the customer accepts 68 the quote within the given time period, a sales person for the merchant inputs the quote number from the voucher into the POS terminal and the sales person will then swipe a new plastic card with an identification number, one of a plurality held in the database, encoded and displayed thereon through a card reader component of the POS terminal. The card, which is encoded with a BIN/IIN number, is then provided to the customer and the sales person will then collect money from the customer at the POS terminal, typically for the product and the service, by credit, debit or cash. Furthermore, by swiping the card through the card reader, the POS terminal associates 72 the quote number with the provided identification number in the database over the network. The sales person at the POS terminal then prints a receipt of purchase of the product and service for the customer, with the quote number included, to be provided to the customer with the card. In addition, the card and the receipt may be presented in a paper sleeve envelope with warranty terms and conditions contained therein to satisfy warranty obligations.

The customer then logs onto a designated website and is prompted to enter 74 the provided quote number on the receipt and the identification number on the card for authentication to enter purchase related details into the database. The customer enters the 12 digit quote number and the 16 digit card BIN/IIN number into the appropriate fields of the website to permit access 76 over the network. Once access is obtained, the customer is presented, via the website, with a summary of the quote, including manufacturer's warranty coverage period, extended warranty coverage period (and date that this will start and cease), purchase amount, and details of the merchant where the product was purchased from. The customer is then taken through a wizard to complete the remaining details. That is, the customer enters 78 purchase related details including: customer email address, date of birth, postal address, product brand, model, colour, size, serial number, and, in some cases, a description and photographs of the product. Once the customer has completed the wizard and entered all the required details, an email confirmation is sent to the entered email address with a copy of the entered details for the customer's records.

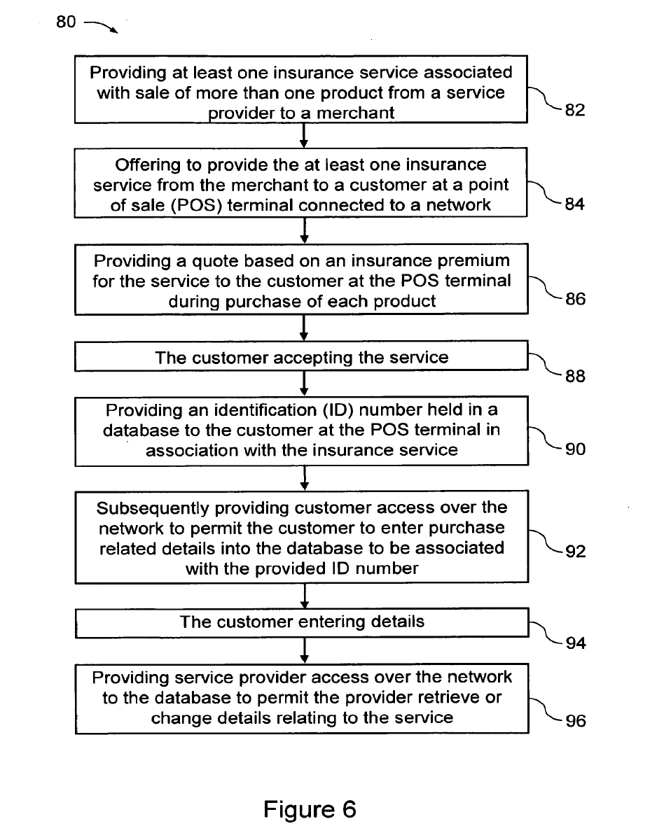

FIG. 6 shows a method 80 of providing a service in accordance with the above described method, but with reference to the role of the service provider. As with the above examples, the service provider provides 82 insurance services, such as extended warranties, for a plurality of products sold by a plurality of merchants, or for a plurality of categories of products sold by merchants. It can be seen from FIG. 6 that the merchant then offers to provide 84 these services to a customer at a POS terminal and a quote is then issued to the customer in the manner described above. The quote is provided 86 on the basis of insurance premiums for the particular category of goods, for example plasma televisions may have a higher insurance premium than LCD televisions due to their reduced longevity. However, as above, the customer accepts 88 the service and an identification number is provided 90 so that the customer can obtain access, using the identification number and quote number, to enter 94 purchase related details into the database and to minimise the time required at the POS terminal by a sales person. In addition, the service provider is provided 96 access over the network to permit retrieval or changing of details relating to the offered insurance services.

Persons skilled in the art will also appreciate that the above methods could be embodied in program code. The program code could be supplied in a number of ways, for example on a computer readable medium, such as a disc or a memory, or as a data signal (for example, by downloading it from a server).

It will be understood to persons skilled in the art of the invention that many modifications may be made without departing from the spirit and scope of the invention, in particular it will be apparent that certain features of the invention can be combined to form further embodiments.

It is to be understood that, if any prior art publication is referred to herein, such reference does not constitute an admission that the publication forms a part of the common general knowledge in the art, in Australia or any other country.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

1. A method for providing a service associated with sale of a product from a merchant to a customer at a point of sale (POS) terminal connected to a server via a network, the method comprising:
generating a quote to provide a service associated with sale of the product to said customer based on data communicated from the POS terminal to the server;
providing a quote number identifying the quote;
providing one of a plurality of identification numbers held in a database of the server at the point of sale terminal in order to identify the product being sold;
establishing a record in the database of the server that associates the quote number for the quote for the service with said provided identification number;
subsequently providing access over the network to permit, within a given time period, acceptance of the quote corresponding to the quote number associated with the identification number; and
issuing a new quote upon the customer seeking to accept the quote subsequent to expiry of the time period.

2. A method as claimed in claim 1, further comprising providing an encodable card with said provided identification number encoded and displayed thereon.

3. A method as claimed in claim 1, further comprising using said provided identification number and said associated quote number for authentication to obtain customer access over the network to permit said customer to enter purchase related details into the database to be associated with the provided identification number.

4. A method as claimed in claim 3, further comprising providing customer access to said database via a website to enter purchase related details from a terminal remote from the network.

5. A method as claimed in claim 1, wherein said point of sale terminal is an Electronic Funds Transfer at Point of Sale (EFTPOS) device.

6. A method as claimed in claim 1, wherein the service associated with sale of the product is at least one insurance service provided by a service provider.

7. A method as claimed in claim 6, further comprising providing service provider access over the network to the database to retrieve or change details relating to the service.

8. A system for providing a service associated with sale of a product from a merchant to a customer, the system comprising:
a server comprising a database; and
a point of sale (POS) terminal connected to a server via a network, the POS terminal arranged to receive payment for purchase of said product, and to provide one of a plurality of identification numbers held in the database,
the POS terminal arranged to communicate data to the server to enable generation of a quote to provide a service associated with sale of the product to said customer,
the system further arranged to:
provide a quote number identifying the quote;
establish a record in the database of the server that associates the quote number for the service with said provided identification number;
subsequently provide access over the network to permit, within a given time period, acceptance of the quote corresponding to the quote number associated with the identification number; and
issue a new quote upon the customer seeking to accept the quote subsequent to expiry of the time period.

9. A system as claimed in claim 8, wherein the point of sale terminal is further adapted to associate said quote number with said provided identification number on a card when said card is swiped through a card reader connected to said POS terminal.

10. A non-transitory computer readable medium comprising computer program code which when executed implements the method of claim 1.
